(19) United States
(12) Patent Application Publication
(10) Pub. No.: US 2025/0285013 A1
(43) Pub. Date: Sep. 11, 2025

(54) Method and Apparatus for Training a Data-Based Model and for Evaluating and Selecting a Selection Function for Active Learning of a Data-Based Model

(71) Applicant: Robert Bosch GmbH, Stuttgart (DE)

(72) Inventors: Ernst Kloppenburg, Ditzingen (DE); Konrad Groh, Stuttgart (DE); Thomas Spieker, Weissach (DE)

(21) Appl. No.: 18/860,327

(22) PCT Filed: Apr. 21, 2023
(86) PCT No.: PCT/EP2023/060519

§ 371 Date: Oct. 25, 2024

(30) Foreign Application Priority Data
Apr. 28, 2022 (DE) 10 2022 204 172.0

(51) Int. Cl. G06N 20/00

(52) U.S. Cl. CPC G06N 20/00

(57) ABSTRACT

A method for evaluating a selection function for an active learning method of training a data-based model includes (i) providing training data sets and validation data sets which each associate an input data point with a label, (ii) performing a training of the data-based model using an active learning method on the basis of the selection function based on the training data sets, (iii) generating multiple evaluation quantities of test data sets by resampling from the validation data sets, (iv) determining a model quality and a level of uncertainty for the model quality on the basis of a statistical evaluation of the model performance of the data-based model based on the generated test data sets, and (v) maintaining or discarding the selection function based on the model quality and level of uncertainty.

### TECHNICAL FIELD

The invention relates to data-based models, such as neural networks, and more particularly to methods for providing and improving a training process for a data-based model.

### TECHNICAL BACKGROUND

Data-based models, such as neural networks and the like, are superior to conventional mathematical or physically motivated models for various complex problems. However, the model quality of a data-based model depends significantly on the quality and number of training data sets with which the data-based model is trained. Labeling input data points, i.e., associating a desired output to an input data point, is time consuming and/or expensive, and is therefore the driving cost factor. Thus, the effort to provide a sufficient quantity of training data sets can be reduced by, on the one hand, decreasing the number of training data sets needed for sufficient training of the data-based model and/or, on the other hand, not labeling redundant input data points.

### DISCLOSURE OF THE INVENTION

According to the present invention, a method for evaluating a selection function according to claim 1, a method for training a data-based model, as well as corresponding devices are provided according to the subordinate claims.

Further embodiments are specified in the dependent claims.

In a first aspect, a method for evaluating a selection function for an active learning method of training a data-based model is provided, with the steps of:
providing training data sets and validation records each associating an input data point with a label;
performing a training of a data-based model using an active learning method on the basis of the selection function based on the training data sets;
generating a plurality of evaluation quantities of test data sets by resampling the validation data sets;
determining a model quality and an uncertainty level for the model quality based on a statistical evaluation of the model performance of the data-based model based on the generated test data sets;
maintaining or discarding the selection function based on the model quality and level of uncertainty.

System functions for a technical system may be provided in whole or in part using a data-based model. Such a data-based model must be trained. To train the data-based model, training data sets are provided that describe the system behavior and associate a model output with an input data point.

Training of the data-based model may be carried out efficiently using an active learning method. Active Learning is a promising strategy for training data-based models and is an approach to reducing input data point labeling by minimizing the number of training data sets needed for efficient training. In so doing, one or more unlabeled input data points, e.g., from a predetermined number of input data points, are selected or determined iteratively using an acquisition function. The selection function is defined so that the input data points are selected such that in a subsequent training with training data sets supplemented by the selected labeled input data point or the selected labeled input data points, the greatest improvement in the model quality of the data-based model, i.e., its model accuracy, is achieved. The possible selection functions are diverse, and it is not usually readily apparent which selection function will result in the fastest possible training of the data-based model, in which a desired image quality is achieved according to the predetermined task.

Validation data sets are in the same format as training data sets and are generated in a comparable manner. The validation data sets are only indirectly used for model training and are used to determine an underfitting or overfitting of the training state of the data-based model. Validation data sets may be utilized in a per se known manner to evaluate model quality and to check a termination criterion for the training.

The selection function selecting the unlabeled input data points for a subsequent label determination may be made based on an evaluation of the selection function for the purpose of improving the model quality of the data-based model to be created using the active learning method. Typically, additional validation data sets may be used to evaluate the model quality used to evaluate the selection function.

Conventionally, the selection function is evaluated with the quantity of the validation data sets by determining a model quality of the data-based model generated therewith. However, this approach is not economical when labeling input data points in order to provide validation data sets is laborious because a greater number of validation data sets are needed for this approach. In addition, the evaluation of the achieved model quality may be inaccurate because, especially with a small number of available validation data sets, the determined model quality is not representative due to a possible non-representative distribution of the validation data sets.

Using the above method, each evaluation quantity of test data sets is generated from the validation data sets using a resampling method, such as a boot-strapping method, to overcome the problem identified above when there are too few validation data sets for evaluating the achieved model quality. In the resampling method, statistics are calculated based on multiple samples (evaluation quantities) from the validation data sets.

Resampling for generating multiple evaluation quantities of test records is performed by randomly selecting test records (drawing with reserves) from the original quantity of validation data sets. The evaluation quantities of test records obtained in this manner may have the same or a different number of test records from the validation records. The plurality of evaluation quantities allow for the creation of statistics from model qualities resulting in an average model quality and an uncertainty level, in particular in the form of a confidence interval. Model performance evaluates the statistical distribution of model qualities.

By providing a variety of evaluation quantities of test data sets, a model quality and an uncertainty level for the model quality may be provided that allow a selection function to be evaluated for a training process with Active Learning. In particular, indicating model quality in connection with the corresponding level of uncertainty makes it possible to determine how the use of a particular selection function affects an improvement of the data-based model.

With the above approach, it is possible to improve the evaluation of the selection function according to which new input data points are selected in Active Learning for subsequent determination of labels (annotation). A model quality and a degree of uncertainty, i.e., a corresponding confidence interval, are determined using a resampling or boot strap method, which allows the model quality of the data-based model to be evaluated after training with an active learning approach based on a predetermined selection function and thereby makes it possible to evaluate the suitability of the selection function.

Overall, the above method allows for recognizing whether a selection function used for a given model training of a data-based model is better or worse compared to a training performed with another selection function, or only incidentally came about through a favorable selection of the test data sets.

Furthermore, the selection function used may be confirmed or discarded depending on the model quality and level of uncertainty, in particular depending on a level of significance dependent on the model quality and level of uncertainty, in particular based on a threshold comparison.

For example, the level of significance may be determined using a weighted sum of the model quality and the level of uncertainty.

In particular, the selection function used may be used to create one or more further input data points or to select one or more further input data points from provided input data points as part of an active learning training process, wherein labels are determined for the further input data points, so as to generate further training data sets, wherein the further training data sets are added to the existing training data sets and further training of the data-based model is performed.

Further, the training of the data-based model using the active learning method may be performed multiple times on the basis of the selection function based on the training data sets.

According to one embodiment, the method of training a first data-based model and a second data-based model may be performed using a first and a second selection function different from the first, wherein, for the first selection function and the second selection function, respectively, a resulting model quality and a corresponding confidence are determined, wherein the first or the second selection function is selected depending on a comparison based on the resulting model qualities and corresponding measures of uncertainty, or depending on the resulting levels of significance, to generate further training data sets and further train the data-based model accordingly.

### BRIEF DESCRIPTION OF THE DRAWINGS

Preferred embodiments are described in more detail below with reference to the accompanying drawings. Shown are:

FIG. 1 a schematic illustration of a technical system having an actuator and a control unit in which a data-based model is implemented to carry out regulation or control of the actuator of the technical system;

FIG. 2 a flowchart illustrating a method for training the data-based model using an active learning method and for evaluating the selection function; and

FIG. 3 a flowchart illustrating a method for training the data-based model and evaluating and selecting one of two selection functions to perform further training.

### DESCRIPTION OF EMBODIMENTS

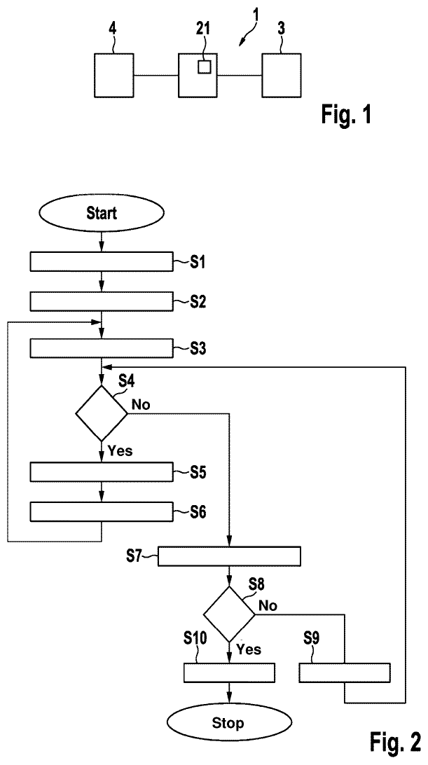

FIG. 1 shows a schematic diagram of a technical system 1 comprising a control unit 2, an actuator 3 and a sensor 4.

The actuator technology 3 may comprise one or more actuators or the like to convert an activation variable A into a physical influencing variable for the technical system 1, for example a movement of the technical system 1 or a part thereof, a temperature change, an emission of electromagnetic radiation, and the like.

Using one or more sensor units, the sensor technology 4 can record one or more system variables, such as a speed, a pressure, an electrical quantity, a temperature, a position of an element, and the like, and/or one or more environmental variables, such as ambient temperature, air pressure, and the like, as sensor variables and provide them to the control unit 2.

The control unit 2 may provide, in the sense of a control or regulation or a performance of an algorithm, one or more activation variables A for activating the actuator 3, in particular based on sensor variables of the sensor technology 4. The function in the control unit 2 may be performed in whole or in part using at least one data-based model 21. The data-based model 21 maps one or more sensor variables, or quantities derived therefrom, and/or one or more default variables to at least one system variable. The system variable may correspond directly or indirectly to the activation signal A.

The data-based model 21 may correspond to a neural network, a Gaussian process, or another trainable non-parametric function. The data-based model is trained by assigning one or more system variables to the one or more sensor variables and/or the one or more default variables that, taken together, make up an input point. Training of the data-based model is carried out based on training data sets each comprising an input data point and one or more system variables associated with it as a label. Labels for the respective input data points can typically be determined by laborious measurements on a test bench or in the field or by simulations. Generally, in particular in a test bench measurement, the cost of determining a label to train a data-based model is significant, and it is thus desirable to reduce or keep the number of training data sets required for the training of the data-based model as low as possible.

Examples of technical systems utilizing a data-based system model 32 and at least one signal time series in an input data set to be evaluated by the system model 32 are diverse.

For example, a speed of an electric machine, along with additionally sensed engine temperatures, may be determined through evaluation in a correspondingly trained system model when a signal time series is determined in the form of a progression of a motor current for a predetermined period of time, as part of the input data set to be evaluated by the data-based model 21. Further variables of the input data set may be an engine temperature and/or one or more variables determining a load of the electric machine. The signal time series indicates the progression of the motor current up to a specified current evaluation time. The evaluation results in a current speed of the electric machine as the initial variable.

As another example, a data-based model 21 may be used to determine an injection amount of fuel in an injection system for an internal combustion engine. In this case, fuel for operating the internal combustion engine is injected into a combustion chamber of a cylinder via an injection valve. To this end, fuel is supplied to the injection valve via a fuel supply, through which fuel is provided in a manner known per se (e.g., common rail) under a high fuel pressure. The injection valve has an electromagnetically or piezoelectrically controllable actuator unit coupled to a valve needle. By controlling the actuator unit, the valve needle is moved longitudinally and releases a portion of a valve opening in the needle seat in order to inject the pressurized fuel into the combustion chamber of the cylinder. Using a piezo sensor, pressure changes in the fuel guided through the injector may be determined as a voltage signal, which may be sensed and provided as a sensor signal time series. The injection amount may be determined by knowing an accurate timing of opening the injector in a manner which is itself known per se. The opening time is determined by the correspondingly trained data-based model 21 based on an input data set comprising the signal time series of the voltage signal as vector and the fuel pressure. The data-based model 21 may then output the opening time as a probability vector or directly as a time variable.

As another example, the data-based model 21 may be used to predict the state of a driver of an automotive vehicle, for instance to detect driver fatigue. For this purpose, vehicle-relevant variables can be provided as temporal profiles in the form of signal time series, such as a progression of steering positions, a progression of the driving speed and/or a progression of the driver's head positions. The initial variable after evaluation in the correspondingly trained system model provides a probability for driver fatigue.

FIG. 2 shows a flowchart illustrating a method for training the data-based model using an active learning method.

In step S1, initially one or more input data points are provided, each of which comprises one or more sensor variables and/or one or more default variables, as described above.

For this purpose, in step S2, a label is determined from one or more system variables, as described above, so that a training data set or a validation data set is formed from an input data point and the associated label, respectively. This results in a quantity of multiple training data sets and a quantity of multiple validation data sets.

Using the one or more training data sets and/or supplemented training data sets as described below, the data-based model is now trained in step S3. Training is carried out according to methods known per se, e.g., based on back-propagation methods.

In a step S4, a review is conducted to determine whether further training data sets are necessary to improve the data-based model according to a predetermined termination criterion. For example, validation records may be used to review a termination criterion for model training. If this is the case (alternative: yes), the method continues with step S5. Otherwise (alternative: no), the method continues with step S7.

Then, in step S5, a quantity of multiple further input data points is provided as a candidate for one or more training data sets to be determined subsequently. Using a predetermined selection function, one or more input data points are selected from these input data points for labeling.

In a subsequent step S6, the respective one or more selected input data points are provided with a label either on the test bench or by a measurement in the field or by simulation to form new training data sets and/or validation data sets.

By returning to step S3, the data-based model is trained further or re-trained with the training data sets supplemented with the new training data sets.

In step S7, the model quality of the trained data-based model 21 is evaluated. The evaluation is performed using evaluation quantities of test records generated from the existing validation records using a resampling method.

The evaluation is performed by statistically evaluating quality variables resulting for each test data set from an assessment quantity of test data sets. For example, the quality variables may result from the standardized average deviations (L2 norm or the like) between the labels of the test data sets of the corresponding evaluation quantity and the model outputs of the data-based model for the respective input data points of the test data sets of the corresponding evaluation quantity.

The model quality results as a mean or median of the quality variables and an uncertainty level/confidence from the scattering or variance in the quality variables for an evaluation quantity of test records.

In step S8, the model quality and its degree of uncertainty can be evaluated according to an evaluation criterion.

For example, the assessment criterion may provide a threshold comparison with a predetermined significance threshold, in which a level of significance, for example a weighted sum of the model quality or the reciprocal value of the model quality and the reciprocal value of the measure of uncertainty, respectively, may be formed.

If the evaluation criterion is not met (alternative: no), then a new selection function (e.g., from a list of predetermined selection functions) can be provided in step S9 for re-training or further training of the data-based model according to the described method and the method can be continued with step S4. Otherwise (alternative: yes), the method may end or, in step S10, the training of the data-based model may be continued with the Active Learning method with the existing selection function.

The convergence of the above Active Learning process will depend to a considerable extent on the selection function chosen. The selection function is currently determined in an empirical and should be done in a way that optimizes improvement of the data-based model as much as possible with each new training data set added. It is proposed to determine the test data sets from the respective underlying validation data sets according to a resampling method to evaluate the model quality accordingly, as well as a level of uncertainty with regard to the model quality. Since the sampling according to the resampling method can be used to set the number of usable evaluation quantities of test data sets at any level without the need for additional measurements, a statistical evaluation can now be carried out that can indicate a model quality and the level of uncertainty in the assessment of the model quality. This method is applicable even with a small number of available validation data sets.

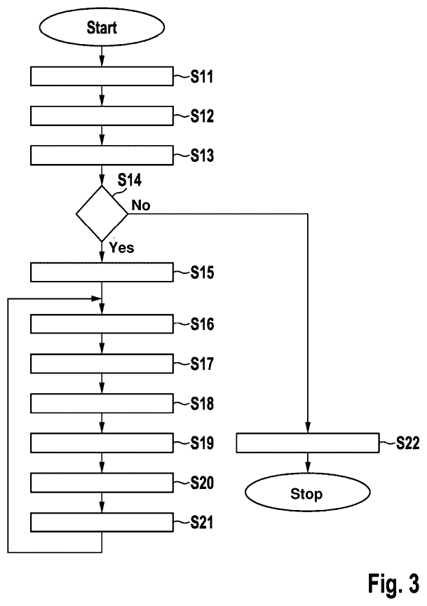

FIG. 3 uses a flow chart to illustrate a method for training a data-based model using two competing active learning selection functions.

In step S11, firstly one or more input data points are provided, each of which is comprised of one or more sensor variables and/or one or more default variables, as described above. To this end, a first quantity of input data points and a second quantity of input data points may be generated, which may be identical at the beginning of the method.

To this end, in step S12, a label is determined for each input data point from one or more system variables, such that a training data set or a validation data set is formed in each case from an input data point and the associated label. This results in a quantity of multiple training data sets and a quantity of multiple validation data sets.

Using the training data sets and the supplemented first and second set of training data sets as described below, a data-based model or a first and a second data-based model, respectively, are now initially trained in step S13. Training is carried out according to methods known per se, e.g., based on back-propagation methods.

Accordingly, a first set of training data sets and a first set of validation data sets may be formed from the first input data points and a second set of training data sets and a second set of validation data sets may be formed from the second input data points.

In a step S14, a review is conducted to determine whether further training data sets are necessary to improve the data-based model according to a predetermined termination criterion. For example, the first and second set of validation data sets may be used to check the respective termination criterion for the model training. If this is the case (alternative: yes), the method continues with step S15. Otherwise (alternative: no), the method continues with step S22.

Then, in step S15, a quantity of multiple further input data points is provided as a candidate for one or more training data sets to be determined subsequently.

In step S16, using a predetermined first and a predetermined second selection function, respectively one or more first and second further input data points are selected from the quantity of input data points.

In a subsequent step S17, the one or more first further input data points and the one or more second further input data points are provided with a label either on the test bench or by a measurement in the field or by simulation to form first and second further training data sets.

In step S18, the training data sets are supplemented by adding the first further training data sets to a first set of training data sets and the training data sets are supplemented by adding the second further training data sets to a second set of training data sets.

In step S19, the data-based model is further trained or re-trained with the first and second set of training data sets supplemented with the first and second additional training data sets, respectively.

In step S20, the first and second trained data-based model are evaluated. The evaluation is performed according to the above method using evaluation quantities of test records generated from the existing validation records using a resampling method.

Beyond the determination of quality variables (see above) it is possible to determine a model quality and an uncertainty variable associated with the corresponding selection functions for the first and second data-based models, respectively.

The training method may be continued in step S21 subsequently based on the selection function for which significantly better model quality has been obtained. In addition, the method is continued with either the first or second model, which ever one has a model quality that has been better rated. The other data-based model in this case may be discarded.

The method may be performed again by returning to step S16, by discarding the poorer selection function and associated data-based model and testing adding a new selection function to the respective remaining better selection function. This may be repeated. In this way, the selection function can be successively improved so that a significantly better model quality results with respect to the cost of label extraction with a smaller number of training data sets.

The significantly better model quality can be determined by determining a level of significance as a comparison value from the model quality and the uncertainty measure, e.g., using a weighted sum as described above.

Resampling does not improve the expected result of the test statistics (here the model performance). That is, we still select the data-based model that has the highest model quality according to the metric selected based on the evaluation quantities of the test data sets. The resampling only adds a confidence interval to the average of the model quality determined in this way. That is, there is an interval in which the determined model quality would lie with a certain probability if the entire experiment were repeated.

The above method makes it possible to determine suitable selection functions based on the achieved model qualities and levels of uncertainty. Selection functions with levels of significance that can enable high model quality can be made available for selection for subsequent training procedures.

1. A computer-implemented method for evaluating a selection function for an active learning method of training a data-based model, comprising:
providing training data sets and validation data sets each associating an input data point with a label;
performing a training of the data-based model using an active learning method on the basis of the selection function based on the training data sets;
generating multiple evaluation quantities of test data sets by resampling from the validation data sets;
determining a model quality and a level of uncertainty for the model quality based on a statistical evaluation of the model performance of the data-based model based on the generated plurality of evaluation quantities of test data sets; and
maintaining or discarding the selection function based on the model quality and level of uncertainty.

2. The method according to claim 1, wherein the selection function used is confirmed or discarded depending on the model quality and level of uncertainty depending on the level of significance which is dependent on the model quality and level of uncertainty based on a threshold comparison.

3. The method according to claim 2, wherein the level of significance is determined using a weighted sum of the model quality and the measure of uncertainty.

4. The method according to claim 1, wherein the selection function used is used to create one or more further input data points or to select one or more further input data points from provided input data points, wherein labels are determined for the further input data points, to determine further training data sets, and wherein the further training data sets are added to the existing training data sets and further training of the data-based model is performed.

5. The method according to claim 1, wherein training of the data-based model using the active learning method is performed multiple times on the basis of the selection function based on the training data sets.

6. The method according to claim 1, wherein the method for training a first data-based model and a second data-based model is carried out using a first and a second selection function different therefrom, wherein, for the first selection function and the second selection function, respectively, a resultant model quality and a corresponding level of uncertainty are determined, and wherein the first or the second selection function is selected on the basis of a comparison based on the resulting model qualities and corresponding levels of uncertainty, in order to generate further training data sets and further train the data-based model accordingly.

7. The method according to claim 1, wherein the validation data sets are used to verify a termination criterion for training the data-based model and/or for determining an overfitting or underfitting.

8. The method according to claim 1, wherein the trained data-based model is used to control, regulate, or operate a technical system.

9. An apparatus for performing the method according to claim 1.

10. A computer program product comprising commands which, when the program is executed by at least one data processing device, cause the data processing device to perform the steps of the method according to claim 1.

11. A machine-readable storage medium comprising commands which, when executed by at least one data processing device, cause the data processing device to perform the steps of the method according to claim 1.
